(19) United States
(12) Patent Application Publication
(10) Pub. No.: US 2011/0033778 A1
(43) Pub. Date: Feb. 10, 2011

(54) POLYMER ELECTROLYTE MEMBRANE

(75) Inventors: Takefumi Kawata, Tsukuba-shi (JP); Sho Kanesaka, Tsukuba-shi (JP); Dai Iwahara, Kashihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 12/921,732

(22) PCT Filed: Mar. 10, 2009
(86) PCT No.: PCT/JP2009/054987

§ 371 Date: Sep. 9, 2010

(30) Foreign Application Priority Data
Mar. 11, 2008 (JP) 2008-060809

(51) Int. Cl. H01M 8/10; C08J 5/20

(52) U.S. Cl. 429/493; 429/492; 521/27

(57) ABSTRACT

A polymer electrolyte membrane, wherein the period length L in the membrane surface direction, which period length is defined by formula (1) and is measured by using a small-angle X-ray diffractometer, is less than 52.0 nm:

L=λ₁/(2 sin(2θᵢ/2)) (1)
wherein 2θᵢ represents a scattering angle in the membrane surface direction and λ₁ represents the wavelength of X-rays used when the scattering angle in the membrane surface direction is measured.

### TECHNICAL FIELD

The present invention relates to a polymer electrolyte membrane to be used in a solid polymer fuel cell, and a method for preparing the same.

### BACKGROUND ART

A solid polymer fuel cell (hereinafter sometimes referred to as a “fuel cell”) is a power-generating device which generates electricity using a chemical reaction of hydrogen with oxygen, and is greatly expected as one of next-generation energies in the fields of the electric appliance industry, the automotive industry, and the like.

The solid polymer fuel cell basically includes two catalyst electrodes and a polymer electrolyte membrane interposed between the electrodes. Hydrogen, which is a fuel, is ionized at one of the electrodes and hydrogen ions are diffused into the polymer electrolyte membrane and then bound to oxygen at the other electrode. At this time, when the two electrodes are in connection with an external circuit, there is a flow of electric current and power is supplied to the external circuit. Herein, the polymer electrolyte membrane functions to diffuse hydrogen ions as well as to physically separate hydrogen from oxygen in the fuel gas and also block the flow of electrons.

Examples of such a polymer include a perfluoroalkyl sulfonic acid polymer, which is commercially available under the name of Nafion (DuPont, registered trademark).

The membrane which is composed of a perfluoroalkyl sulfonic acid polymer is prepared by applying a solution of a perfluoroalkyl sulfonic acid polymer dissolved in a mixed solvent of water, 1-propanol, and 2-propanol to a glass plate and drying it at 25° C. (see, for example, JP-H9-199144-A). This conventional polymer electrolyte membrane has high ion conductivity, but there is a desire to have even higher ion conductivity.

### DISCLOSURE OF INVENTION

Therefore, it is an object of the present invention to provide a polymer electrolyte membrane having excellent ion conductivity, particularly ion conductivity in the membrane thickness direction.

The present inventors made extensive investigations on a polymer electrolyte membrane having high proton conductivity in consideration of the above-described problems in the prior art.

As a result, it was found that a resulting polymer electrolyte membrane whose period length in the membrane surface direction measured by using small-angle X-ray scattering measurement had been set into a certain range would be a polymer electrolyte membrane having excellent proton conductivity. In addition, it was also found that the polymer electrolyte membrane of the present invention can be prepared by controlling the temperature and the humidity to certain conditions in a drying step done after film formation, thereby accomplishing the present invention.

According to the present invention, proton conductive membranes as shown below are provided.

<1> A polymer electrolyte membrane, wherein the period length L in the membrane surface direction, which period length is defined by formula (1) and is measured by using a small-angle X-ray diffractometer, is less than 52.0 nm:

L=λ₁/(2 sin(2θᵢ/2)) (1)

wherein 2θᵢ represents a scattering angle in the membrane surface direction and λ₁ represents the wavelength of X-rays used when the scattering angle in the membrane surface direction is measured.

<2> The polymer electrolyte membrane according to <1>, wherein the anisotropy factor k, which is defined by formula (2) and is measured by using a small-angle X-ray diffractometer, is more than 0.440:

k=(2θᵢ/λ₁)/(2θ_{z}/λ₂) (2)

wherein 2θᵢ and 2θ_{z} respectively represent a scattering angle in the membrane surface direction and a scattering angle in the membrane thickness direction, and λ₁ and λ₂ respectively represent the wavelength of X-rays used when a scattering angle in the membrane surface direction is measured and the wavelength of X-rays used when a scattering angle in the membrane thickness direction is measured.

<3> The polymer electrolyte membrane according to <1> or <2>, comprising a polymer having an ion-exchange group.

<4> The polymer electrolyte membrane according to any of <1> to <3>, comprising a block copolymer containing at least one block having an ion-exchange group and at least one block having no ion-exchange groups.

<5> The polymer electrolyte membrane according to any of <1> to <4>, comprising a block copolymer containing one or more blocks having an aromatic group in the main chain or a side chain and having an ion-exchange group and one or more blocks having an aromatic group in the main chain or a side chain and having no ion-exchange groups.

<6> The polymer electrolyte membrane according to any of <1> to <5>, comprising a polyarylene-based block copolymer containing one or more blocks having at least one kind of an ion-exchange group selected from the group consisting of a phosphonic acid group, a carboxylic acid group, a sulfonic acid group and a sulfonimide group, and one or more blocks having no ion-exchange groups.

<7> A solid polymer fuel cell formed by using the polymer electrolyte membrane according to any of <1> to <6>.

<8> A method for preparing a polymer electrolyte membrane, the method comprising applying a solution containing a polymer electrolyte to a substrate and removing a solvent to obtain the polymer electrolyte membrane, wherein in the solvent-removing step, the specific humidity H (wherein 0≦H≦1) of the atmosphere of the step is kept in a range satisfying formula (3), and the Celsius temperature T of the atmosphere of the step is kept in a range satisfying formula (4):

0.0033T−0.2<H≦0.5 (3)

60≦T≦160 (4)

### BRIEF DESCRIPTION OF DRAWINGS

FIG. 1 is a schematic view showing a cross-sectional configuration of a fuel cell of the present embodiment.

### EXPLANATION OF REFERENCE

10 Fuel cell
12 Proton conductive membrane
14a Catalyst layer
14b Catalyst layer
16a Gas diffusion layer
16b Gas diffusion layer
18a Separator
18b Separator
20 Membrane-electrode assembly (MEA)

### BEST MODE FOR CARRYING OUT THE INVENTION

Hereinbelow, the preferred embodiments of the present invention will be described in detail.

The polymer electrolyte membrane of the present invention is characterized in that the period length L in the membrane surface direction, which period length is defined by formula (1) and is measured by using a small-angle X-ray diffractometer, is less than 52.0 nm:

L=λ₁/(2 sin(2θᵢ/2)) (1)

wherein 2θᵢ represents a scattering angle in the membrane surface direction and λ₁ represents the wavelength of X-rays used when the scattering angle in the membrane surface direction is measured.

While the reason is not clear, it is preferable that the polymer electrolyte membrane of the present invention have a certain type of structural anisotropy. Specifically, in the small-angle X-ray scattering measurement, it can be seen that the anisotropy k defined by formula (2) shows a strong correlation with high proton conductivity, and the k is preferably more than 0.440, and more preferably more than 0.500:

k=(2θᵢ/λ₁)/(2θ_{z}/λ₂) (2)

wherein 2θᵢ and 2θ_{z} respectively represent a scattering angle in the membrane surface direction and a scattering angle in the membrane thickness direction, and λ₁ and λ₂ respectively represent the wavelength of X-rays used when a scattering angle in the membrane surface direction is measured and the wavelength of X-rays used when a scattering angle in the membrane thickness direction is measured.

Furthermore, the scattering angle of X-rays is usually referred to as 2θ (“Jikken Kagaku Koza 11”, edited by The Chemical Society of Japan, Maruzen, p. 2), and therefore the scattering angle in the membrane surface direction and the scattering angle in the membrane thickness direction are referred to as 2θᵢ and 2θ_{z}, respectively.

As the polymer electrolyte according to the present invention can be suitably used a known polymer electrolyte. Also, a known polymer electrolyte and a known non-electrolytic polymer may be used appropriately in combination. In addition, a known non-electrolytic polymer and a known low-molecule electrolyte may be used appropriately in combination. Among these known polymer electrolytes, electrolytes which tend to undergo microphase separation into at least two or more phases can be suitably used in the present invention.

Preferred as an example is one which has one or more sites having an ion-exchange group and one or more sites having substantially no ion-exchange groups, and which can exhibit a microphase-separated structure composed of at least two phases including a region in which sites having an ion-exchange group are mainly aggregated and a region in which sites having substantially no ion-exchange groups are mainly aggregated when being converted into a membrane.

Examples of the polymer electrolyte that tend to be microphase-separated into two or more phases include those including a block copolymer comprising at least one block having an aromatic group in the main chain or a side chain and having an ion-exchange group and at least one block having an aromatic group in the main chain or a side chain and having no ion-exchange groups.

Examples of the aromatic group include divalent monocyclic aromatic groups, such as a 1,3-phenylene group and a 1,4-phenylene group; divalent condensed ring-based aromatic groups, such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group; and divalent aromatic heterocyclic groups, such as a pyridinediyl group, a quinoxalinediyl group and a thiophenediyl group.

The polymer electrolyte used in the present invention may have the aromatic group in any of the main chain and a side chain, but from the viewpoint of the stability of a electrolyte membrane, it preferably has the aromatic group in the main chain. When the polymer electrolyte has the aromatic group in the main chain, the polymer electrolyte may form a polymer main chain by covalent binding of a carbon or nitrogen atom contained in an aromatic ring, or may form a polymer main chain via carbon, or boron, oxygen, nitrogen, silicon, sulfur, phosphorous, or the like being outside an aromatic ring, but from the viewpoint of the water resistance of a polymer electrolyte membrane, a polymer in which a polymer main chain is formed by covalent binding of a carbon or nitrogen atom contained in an aromatic ring or a polymer chain is formed by linking aromatic groups via a sulfone group (—SO₂—), a carbonyl group (—CO—), an ether group (—O—), an amide group (—NH—CO—), or an imide group represented by formula (5) is preferable. Further, the same polymer main chain or different polymer main chains may be used for blocks having an ion-exchange group and blocks having no ion-exchange groups.

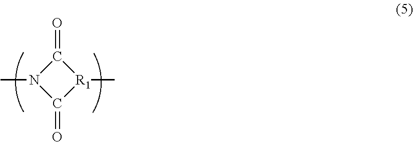

Herein, the “ion-exchange group” refers to a group concerning ion conductivity, particularly proton conductivity when the polymer electrolyte is used in the form of a membrane, “having an ion-exchange group” means that the number of the ion-exchange groups contained per repeated unit is approximately 0.5 or more on average, and “having substantially no ion-exchange groups” means that the number of the ion-exchange groups contained per repeated unit is approximately 0.1 or less on average. While such an ion-exchange group may be any one of a cation-exchange group (hereinafter sometimes referred to as acidic group) and an anion-exchange group (hereinafter sometimes referred to as basic group), a cation-exchange group is preferable from the viewpoint of realizing high proton conductivity.

While the ion-exchange group includes acid groups such as weak acid groups, strong acid groups and super strong acid groups, strong acid groups and super strong acid groups are preferable. Examples of the acidic group include weak acid groups, such as a phosphonic acid group and a carboxylic acid group; and strong acid groups, such as a sulfonic acid group, a sulfonimide group (—SO₂—NH—SO₂—R, wherein R represents a monovalent substituent such as an alkyl group and an aryl group), and preferably used among these are a sulfonic acid group or a sulfonimide group, which are strong acid groups. Further, it is desirable to make the above strong acid group function as a super strong acid group due to the effect of the electron withdrawing group such as a fluorine atom by replacing a hydrogen atom on a substituent (—R) of the aromatic ring and/or the sulfonimide group by an electron withdrawing group such as a fluorine atom.

These ion-exchange groups may be used alone or two or more ion-exchange groups may be used at the same time. When two or more ion-exchange groups are used, polymers having different ion-exchange groups may be blended and a polymer having two or more kinds of ion-exchange groups in the polymer introduced by such a method as copolymerization may be used. In addition, these ion-exchange groups may have formed salts by being partly or entirely replaced by metal ions or quaternary ammonium ions, and in the case of being used as, for example, a polymer electrolyte membrane for a fuel cell, it is preferable that the ion-exchange groups be in a free acid state where substantially no salt has been formed.

Examples of the aryl group referred to above include aryl groups, such as a phenyl group, a naphthyl group, a phenanthrenyl group and an anthracenyl group; and aryl groups composed of the foregoing aryl groups substituted with a fluorine atom, a hydroxyl group, a nitrile group, an amino group, a methoxy group, an ethoxy group, an isopropyloxy group, a phenyl group, a naphthyl group, a phenoxy group, a naphthyloxy group, or the like.

The introduced amount of the ion-exchange group of the polymer electrolyte according to the present invention, which depends on the intended use or the kind of the ion-exchange group, generally, as expressed by an ion exchange capacity, is preferably from 2.0 meq/g to 10.0 meq/g, more preferably from 2.3 meq/g to 9.0 meq/g, and particularly preferably from 2.5 meq/g to 7.0 meq/g. If the ion exchange capacity is 2.0 meq/g or more, the ion-exchange groups get close to each other, and thus proton conductivity becomes higher, which is thus preferable. On the other hand, if the ion exchange capacity representing the introduced amount of the ion-exchange groups is 10.0 meq/g or less, preparation becomes easier, which is thus preferable.

The polymer electrolyte according to the present invention preferably has a molecular weight, as expressed by a polystyrene-equivalent number average molecular weight, of 5000 to 1000000, and particularly preferably 15000 to 400000.

As the above-described polymer electrolyte, specifically, for example, any of a fluorine-containing polymer electrolyte containing fluorine in the main chain structure and a hydrocarbon-based polymer electrolyte containing no fluorine in the main chain structure may be used, but the hydrocarbon-based polymer electrolyte is preferable. Furthermore, while a combination of a fluorine-containing polymer electrolyte and a hydrocarbon-based polymer electrolyte may be contained as the polymer electrolyte, it is preferable in this case that a hydrocarbon-based polymer electrolyte be contained as a main component.

Examples of the above-described hydrocarbon-based polymer electrolyte include a polyimide-based polymer electrolyte, a polyarylene-based polymer electrolyte, a polyethersulfone-based polymer electrolyte, and a polyphenylene-based polymer electrolyte. These may be contained alone or two or more of them may be contained in combination.

Preferably, one of the above-described polyarylene-based hydrocarbon-based polymer electrolytes is, for example, a block copolymer having a polyarylene structure (hereinafter sometimes referred to as “polyarylene-based block copolymer”). The polyarylene-based block copolymer to be used in the present invention can be suitably synthesized, for example, by using the synthesis method disclosed in JP-2005-320523-A or JP-2007-177197-A.

The polyarylene-based block copolymers can all be suitably used as a member for fuel cells.

Next, using the polyarylene-based block copolymer as an example, a case where the polymer electrolyte is used as a proton conductive membrane of an electrochemical device such as a fuel cell will be described. The application to a proton conductive membrane is not limited to the polyarylene-based block copolymer.

In this case, the polyarylene-based block copolymer is usually used in the form of a membrane, and a method for transforming it into a membrane tends to allow a suitable polymer electrolyte membrane to be easily obtained by using a method of forming a membrane under a specific atmosphere as described later (solution cast method).

Specifically, a membrane is formed by dissolving the polyarylene-based block copolymer of the present invention in a proper solvent, applying the solution to a glass plate by cast-application, and then removing the solvent. The solvent to be used for membrane formation is not particularly limited as far as it can dissolve a polyarylene-based polymer therein and then be removed, and as the solvent, aprotic polar solvents, such as N,N-dimethylformamide (DMF), N,N-dimethylacetamide (DMAc), N-methyl-2-pyrrolidone (NMP) and dimethyl sulfoxide (DMSO); chlorine-containing solvents, such as dichloromethane, chloroform, 1,2-dichloroethane, chlorobenzene and dichlorobenzene; alcohols, such as methanol, ethanol and propanol; and alkylene glycol monoalkyl ethers, such as ethylene glycol monomethyl ether, ethylene glycol monoethyl ether, propylene glycol monomethyl ether and propylene glycol monoethyl ether are suitably used. While these may be used alone or two or more kinds of solvents may, as needed, be used in admixture. Among those, DMSO, DMF, DMAc, and NMP are preferable because of the high solubility of polymers therein.

### (Method for Preparing Polymer Electrolyte Membrane)

Next, the method for preparing the polymer electrolyte membrane of the present invention will be described. The polymer electrolyte membrane can be produced by applying a solution prepared by dissolving a polymer electrolyte in a solvent to a prescribed substrate (applying step), and then evaporating and removing the solvent from the film of the solution applied (solvent-removing step). While as the polymer electrolyte can be used without any particular limitation the polymer electrolytes of the above-described embodiments, a suitable polymer electrolyte membrane as described later tends to be easily obtained by the present method particularly when a polymer electrolyte contains the block copolymer disclosed in JP-2005-320523-A or JP-2007-177197-A.

The application of a solution comprising the polymer electrolyte to a substrate in the applying step can be carried out by, for example, a cast-application method, a casting method, a dipping method, a grade coating method, a spin coating method, a gravure coating method, a flexographic printing method, an ink-jet method, or the like, and the cast-application is preferred.

Preferred as the material of a substrate to which the solution is applied is one which is chemically stable and is insoluble in the solvent to be used. In addition, more preferred as the substrate is one such that after the formation of a polymer electrolyte membrane, the resulting membrane can be easily washed and easily peeled therefrom. Examples of such a substrate include plates, films, and the like, each formed of glass, polytetrafluoroethylene, polyethylene, or polyester (polyethylene terephthalate and the like).

Preferred as a solvent to be used for a solution comprising the polymer electrolyte is one which can dissolve the polymer electrolyte and can be easily removed by evaporation after application. Such a preferable solvent can be suitably selected according to, for example, the structure of the polymer electrolyte.

The solvent can be selected from, for example, among aprotic polar solvents, such as N,N-dimethylformamide, N,N-dimethylacetamide, N-methyl-2-pyrrolidone and dimethyl sulfoxide; chlorine-containing solvents, such as dichloromethane, chloroform, 1,2-dichloroethane, chlorobenzene and dichlorobenzene; alcohol solvents, such as methanol, ethanol and propanol; alkylene glycol monoalkyl ether-based solvents, such as ethylene glycol monomethyl ether, ethylene glycol monoethyl ether, propylene glycol monomethyl ether and propylene glycol monoethyl ether. These may be used alone or two or more of them may be used in combination.

More specifically, when a polymer electrolyte comprising the block copolymer disclosed in JP-2005-320523-A or JP-2007-177197-A, N,N-dimethylformamide, N,N-dimethylacetamide, N-methyl-2-pyrrolidone, or dimethyl sulfoxide is preferable, dimethyl sulfoxide or N,N-dimethylacetamide is more preferable as a solvent, and dimethyl sulfoxide is particularly preferable.

Furthermore, the temperature of the atmosphere of the solvent-removing step is preferably a temperature which is equal to or higher than the freezing point of the solvent, and which is equal to or lower than a temperature that is 50° C. higher than the boiling point of the solvent. If the temperature condition of the atmosphere of the solvent-removing step is below this range, the evaporation of the solvent will become very difficult. On the other hand, if it is over the range, non-uniform evaporation of the solvent tends to occur and thus, the appearance of the polymer electrolyte membrane tends to deteriorate. Accordingly, it is preferable that the temperature be set so as to be kept within such a suitable temperature range.

From the viewpoint of more easily obtaining a polymer electrolyte membrane having a good constitution, the upper limit of the temperature in the solvent-removing step is preferably a temperature that is 10° C. lower than the boiling point of the solvent, and more preferably a temperature that is 20° C. lower than the boiling point of the solvent. Further, the lower limit is preferably a temperature that is 40° C. higher than the freezing point of the solvent. For example, if the solvent is dimethyl sulfoxide, the temperature range in the solvent-removing step is preferably from 60 to 160° C., more preferably from 65 to 140° C., even more preferably from 70 to 120° C., and particularly preferably from 80 to 110° C.

The humidity condition of the atmosphere of the solvent-removing step can be defined as a specific humidity H (wherein 0≦H≦1) according to the temperature in the solvent-removing step.

It is preferable that the specific humidity H of the atmosphere of the step be kept in a range satisfying formula (3), and the Celsius temperature T of the atmosphere of the step be kept in a range satisfying formula (4). More preferably, it is more preferable that the specific humidity H be kept in a range satisfying formula (3), and the Celsius temperature T be kept constant in a range satisfying formula (4).

0.0033T−0.2<H≦0.5 (3)

60≦T≦160 (4)

The specific humidity refers to the amount of water vapor contained in a unit mass of moist air, wherein the amount of water vapor in 1 kg of air is expressed by a kg unit.

If the specific humidity of the atmosphere in the solvent-removing step exceeds this upper limit, condensation in drying equipment easily occurs, and it becomes difficult to obtain an electrolyte membrane having a good shape. On the other hand, if the specific humidity is lower than the lower limit, the ion conductivity in the thickness direction tends to be lowered. Accordingly, it is preferable that the specific humidity be set so as to be kept in such a suitable range.

The atmosphere in the above-described solvent-removing step is preferably controlled until a solution containing the polymer electrolyte applied to the substrate by cast-application is substantially solidified in the solvent-removing step. Herein, being substantially solidified means that even when the substrate is inclined, the solution does not substantially start to flow.

The method for controlling the atmosphere in the above-described solvent-removing step can be modified depending on the polymer electrolyte, the solvent, and the substrate to be used, and the device to be used in the step, as far as not departing from the spirit of the present invention.

### (Polymer Electrolyte Membrane)

Next, the polymer electrolyte membrane of the present invention will be described.

As the polymer electrolyte used in the polymer electrolyte membrane, those mentioned above can be used.

The polymer electrolyte membrane of the present embodiment can be successfully obtained according to the preparation method of the above-described embodiment. This polymer electrolyte membrane is a membrane composed of the polymer electrolyte and has a microphase-separated structure. If the polymer electrolyte comprises the block copolymer of the above-described embodiment, a region having an ion-exchange group is composed of polymer chains having an ion-exchange group in the block copolymer and a region having no ion-exchange groups is composed of polymer chains having no ion-exchange groups in the block copolymer.

A suitable thickness of the polymer electrolyte membrane of the present invention, which depends on the kind of the polymer electrolyte, is from 10 to 300 μm. If the thickness is 10 μm or less, the membrane is likely to have a strength sufficient for practical use. Further, if the thickness is 300 μm or less, the membrane resistance decreases, and thus, there is a tendency that a high output can be obtained when the polymer electrolyte membrane is applied in a fuel cell. The thickness of the polymer electrolyte membrane can be controlled by changing the applied thickness when applying the solution in the above-described preparation method.

### (Fuel Cell)

Next, a fuel cell of a preferable embodiment will be described. This fuel cell comprises the polymer electrolyte membrane in the above-described embodiment.

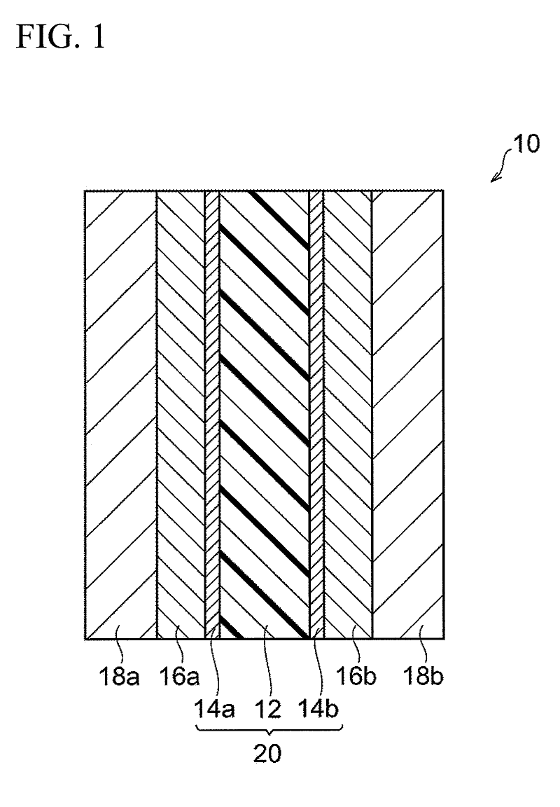

FIG. 1 is a schematic view showing a cross-sectional configuration of a fuel cell of the present embodiment. As shown in FIG. 1, in the fuel cell 10, catalyst layers 14a and 14b, gas diffusion layers 16a and 16b, and separators 18a and 18b are sequentially formed on both sides of a polymer electrolyte membrane 12 (proton conductive membrane) composed of the polymer electrolyte membrane in the above-described suitable embodiment. A membrane-electrode assembly (hereinafter abbreviated as “MEA”) 20 is constituted from the polymer electrolyte membrane 12 and a pair of catalyst layers 14a and 14b holding the membrane between them.

The catalyst layers 14a and 14b adjacent to the polymer electrolyte membrane 12 are layers that function as electrode layers in the fuel cell, and either one of these layers is an anode electrode layer and the other is a cathode electrode layer. The catalyst layers 14a and 14b are made of a catalyst composition containing a catalyst, and preferably contain the polymer electrolyte of the above-described embodiment.

The catalyst is not particularly limited as far as it is able to activate a redox reaction with hydrogen or oxygen, and examples thereof include noble metals, noble metal alloys, metal complexes, and baked metal complexes made by baking metal complexes. Among them, platinum fine particles are preferable as the catalyst, and the catalyst layers 14a and 14b may be those that platinum fine particles are supported on a granular or fibrous carbon such as activated carbons and graphite.

Gas diffusion layers 16a and 16b are provided so as to hold both sides of MEA 20 between them and accelerates the diffusion of the source gas into the catalyst layers 14a and 14b. The gas diffusion layers 16a and 16b are preferably ones containing a porous material having electron conductivity. For example, porous carbon nonwoven fabric and carbon paper are preferable since they can transport the source gas into the catalyst layers 14a and 14b efficiently.

The membrane-electrodes-gas diffusion layers assembly (MEGA) includes the polymer electrolyte membrane 12, the catalyst layers 14a and 14b, and the gas diffusion layers 16a and 16b. Such MEGA can be manufactured by, for example, the method shown below. That is, first, a slurry of a catalyst composition is formed by mixing a solution containing a polymer electrolyte and a catalyst. This slurry is applied to carbon nonwoven fabric, carbon paper, or the like for forming the gas diffusion layers 16a and 16b by a spray method or a screen printing method, and then the solvent or the like is evaporated to give a laminated material where a catalyst layer is formed on a gas diffusion layer. Then, the obtained one pair of laminated materials is arranged so that each catalyst layer will be opposed, and the polymer electrolyte membrane 12 is arranged between the catalyst layers and these are subjected to pressure bonding. MEGA having the above-mentioned structure can be thus obtained. In addition, formation of the catalyst layer on the gas diffusion layer can also be carried out in such a way that, for example, the catalyst composition is applied to a prescribed substrate (polyimide, polytetrafluoroethylene, and the like) and dried to form the catalyst layer, and then this layer is transferred onto the gas diffusion layer with a heat press.

Separators 18a and 18b are formed of a material having electron conductivity, and examples of the material include carbon, resin mold carbon, titanium, and stainless steel. Such separators 18a and 18b, not shown in the FIGURE, preferably have ditches that act as flow channels for fuel gas or the like and are formed on the sides facing the catalyst layers 14a and 14b.

The fuel cell 10 can be obtained by holding MEGA like that described above between the pair of separators 18a and 18b, and joining these.

In addition, the fuel cell is not necessarily limited to one having the above-mentioned constitution and may have a different constitution as appropriate. For example, the above-mentioned fuel cell 10 may be one that has the above-described structure and has been sealed with sealing gas or the like. Further, the fuel cell 10 having such a structure may also be practically provided in series where a plurality are connected as a fuel cell stack. The fuel cell having such a constitution can operate as a solid polymer fuel cell in the case where the fuel is hydrogen, or can operate directly as a methanol-type fuel cell in the case where the fuel is an aqueous methanol solution.

While preferable embodiments of the present invention are described above, the present invention is not necessarily limited to these embodiments, and modifications may be made within a range not departing from the spirit of the present invention.

Hereinbelow, the present invention will be described in more detail with reference to Examples, but the present invention is not intended to be limited thereto.

### Synthesis of Polymer Electrolyte

### Synthesis Example 1

A block copolymer 1 (ion exchange capacity=2.39 meq/g, Mw=290,000, Mn=140,000) was obtained which had sulfonic acid group-containing segments composed of the repeating units represented by the following formula:

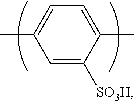

and segments having no ion-exchange groups, represented by the following formula:

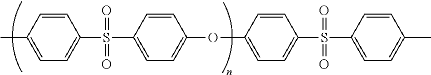

and which was synthesized by using SUMIKAEXCEL PES 5200P (manufactured by Sumitomo Chemical Co., Ltd.) with reference to the method described in Examples 7 and 21 of the pamphlet of International Publication WO2007/043274.

### Synthesis Example 2

A block copolymer 2 was obtained in the same manner as in Synthesis Example 1 except that SUMIKAEXCEL PES 3600 P (manufactured by Sumitomo Chemical Co., Ltd.) was used.

### [Measurement of Conductivity in Membrane Thickness Direction]

For the polymer electrolyte membrane used in the present investigation, the ion conductivity in the membrane thickness direction was measured by the method shown below. First, two cells for measurement that a carbon electrode was pasted on one side of silicon rubber (200 μm in thickness) having an opening of 1 cm² were prepared, and these were arranged so that the carbon electrodes would be mutually opposed. Then, a terminal of a device for measuring impedance was connected directly to the cell for measurement.

The polymer electrolyte membrane was interposed between the cells for measurement and the resistance value between the two cells for measurement was measured at a measurement temperature of 23° C. Thereafter, the resistance value was measured again the polymer electrolyte membrane removed.

The resistance value obtained in the state having the polymer electrolyte membrane and that obtained in the state not having the polymer electrolyte membrane were compared, and on the basis of difference between these resistance values was calculated the resistance value in the membrane thickness direction of the polymer electrolyte membrane. Further, the ion conductivity in the membrane thickness direction was determined from the thus obtained resistance value in the membrane thickness direction. In addition, the measurement was conducted in the state where 1 mol/L of dilute sulfuric acid was in contact with both sides of the polymer electrolyte membrane.

### (Method for Measuring Scattering Angle 2θᵢ in Membrane Surface Direction)

### (Measurement Method 1)

A polymer electrolyte membrane was cut into a round shape having a diameter of 1 cm, and a plurality of sheets capable of obtaining sufficient signal intensity were stacked and held in a sample holder. The two-dimensional scattering pattern was recorded in an imaging plate for 90 minutes by using a CuKα ray (wavelength λ₁: 1.54 Angstrom) that has been monochromatized by an X-ray mirror. The intensity profiles in all directions from the obtained two-dimensional scattering patterns were prepared and integrated. The background signal was removed from the obtained one-dimensional scattering pattern, and in other areas, a scattering angle 2θᵢ in the membrane surface direction was obtained from the scattering angle at which the signal showed the highest value and the intensity was at a maximum.

Here, the signal of 0.08° or lower was the background signal, and was thus removed.

### (Measurement Method 2)

A polymer electrolyte membrane was cut into a round shape having a diameter of 1 cm, and a plurality of sheets enough for obtaining sufficient signal intensity were stacked and held in a sample holder. A two-dimensional scattering pattern was recorded for 90 minutes with a Multi Wire Detector (Hi-STAR) by using a CuKα ray (wavelength λ₁: 1.54 Angstrom) that has been monochromatized by an X-ray mirror. Intensity profiles in all directions were prepared from the obtained two-dimensional scattering patterns and then integrated. Background signals were removed from the obtained one-dimensional scattering pattern, and in other areas, a scattering angle 2θᵢ in the membrane surface direction was obtained from the scattering angle at which the signal showed the highest value and the intensity was at a maximum.

Here, the signals of 0.120° or lower were the background signal, and thus were removed.

### (Method for Calculating Period Length)

The obtained 20θᵢ was applied to formula 1 to obtain a period length L in the membrane surface direction.

L=λ₁/(2 sin(2θᵢ/2)) (1)

wherein λ₁ represents the wavelength of X-rays used when the scattering angle in the membrane surface direction is measured and 2θᵢ represents a scattering angle in the membrane surface direction.

### (Method for Measuring Scattering Angle 2θ_{z} in Membrane Thickness Direction)

### (Measurement Method 3)

As for the polymer electrolyte membrane, the higher-order structure was measured and analyzed by means of a radiation small-angle X-ray scattering device SAX. As the beam line, BL-15A available from the High Energy Accelerator Research Organization was used. The sample film was cut into several cm in length of and 1 mm in width and then used in measurement. It was held in a sample holder so as to keep the X-ray beam incident perpendicular to the membrane cross-section. The optical path length of X-ray passing through the sample was 1 mm. X-rays were applied to the sample (wavelength λ₂: 1.47 Angstrom), and a location optimal for the experiment was determined by remotely controlling a goniometer from the outside of the experiment hutch. The X-ray energy used was 8 keV, the exposure time was 6 minutes, and an imaging plate was used for the detector to record a two-dimensional scattering pattern. The intensity in the meridional direction was taken from the obtained two-dimensional scattering pattern to create a one-dimensional intensity profile. The profile in the case when the sample is not used was subtracted from the obtained intensity profile to obtain a one-dimensional profile. In the obtained profile, an angle at which the signal intensity showed the highest value and the intensity was at a maximum was taken as a scattering angle 2θ_{z}.

In addition, the signals of 0.115° or lower were background signal, and thus were removed.

### (Measurement Method 4)

As for the polymer electrolyte membrane, the higher-order structure was measured and analyzed by means of a small-angle X-ray scattering device NanoSTAR (manufactured by Bruker AXS GmbH) installed with a two-dimensional detector. The sample film was cut into a length of several centimeters and a width of 1 mm and then used in measurement. It was held in a sample holder so as to keep the X-ray beam incident perpendicular to the membrane cross-section. The optical path length of X-ray passing through the sample was 1 mm. CuKα ray (wavelength λ₁: 1.54 Angstrom) that has been monochromatized by an X-ray mirror was applied to the sample. A location optimal for the experiment was determined by remotely controlling a goniometer from the outside of the experiment hutch. A two-dimensional scattering pattern was recorded using a two-dimensional Multi Wire Detector (Hi-STAR) with an exposure time of 60 minutes. After removing the signals affected by specular reflection from the obtained two-dimensional scattering pattern, a circle was drawn which passes a point where the scattering intensity showed the highest value and the intensity was at a maximum and having a center at the beam center, and the angle indicating the intersection between the circle and the meridian was taken as a scattering angle 2θ_{z}.

Further, the signals of 0.120° or lower were background signals, and thus were removed.

### (Method for Calculating Anisotropy k)

The obtained scattering angle was applied to formula (2) to obtain an anisotropy k.

k=(2θᵢ/λ₁)/(2θ_{z}/λ₂) (2)

wherein 2θᵢ and 2θ_{z} respectively represent a scattering angle in the membrane surface direction and a scattering angle in the membrane thickness direction, and λ₁ and λ₂ respectively represent the wavelength of X-rays used when a scattering angle in the membrane surface direction is measured and the wavelength of X-rays used when a scattering angle in the membrane thickness direction is measured.

### Example 1

The polymer electrolyte synthesized according to Synthesis Example 1 was dissolved in dimethyl sulfoxide to prepare a solution having a concentration of 10% by weight. From the obtained solution was produced an about 30 μm thick polymer electrode membrane by using a supporting substrate (PET film, manufactured by Toyobo Co., Ltd., E5000 grade with a thickness of 100 μm) under the conditions of a temperature of 70° C. and a specific humidity of 0.048 kg/kg. This membrane was immersed in 2 N sulfuric acid for 2 hours, then washed with ion-exchange water, and further air-dried to prepare a conductive membrane 1. The formed conductive membrane 1 was subjected to small-angle X-ray scattering measurement in accordance with Measurement Method 1 and Measurement Method 3, and as a result, the scattering angles 2θ_{z} and 2θᵢ in the membrane thickness direction and in the membrane surface direction were 0.340° and 0.185°, respectively, and the period length L in the membrane surface direction and the anisotropy k were 48 nm and 0.52, respectively. The proton conductivity was 0.154 S/cm.

### Example 2

A conductive membrane 2 was prepared by carrying out the experiment in the same manner as in Example 1 except that the temperature was 80° C. and the specific humidity was 0.103 kg/kg. The formed conductive membrane 2 was subjected to small-angle X-ray scattering measurement in accordance with Measurement Method 1 and Measurement Method 3, and as a result, the scattering angles 2θ_{z} and 2θᵢ in the membrane thickness direction and in the membrane surface direction were 0.365° and 0.170°, respectively, and the period length L in the membrane surface direction and the anisotropy k were 51.9 nm and 0.445, respectively. The proton conductivity was 0.146 S/cm.

### Example 3

A conductive membrane 3 was prepared by carrying out the experiment in the same manner as in Example 1 except that the temperature was 90° C. and the specific humidity was 0.116 kg/kg. The formed conductive membrane 3 was subjected to small-angle X-ray scattering measurement in accordance with Measurement Method 1 and Measurement Method 3, and as a result, the scattering angles 2θ_{z} and 2θᵢ in the membrane thickness direction and in the membrane surface direction were 0.370° and 0.175°, respectively, and the period length L in the membrane surface direction and the anisotropy k were 50.4 nm and 0.451, respectively. The proton conductivity was 0.121 S/cm.

### Example 4

The polymer electrolyte synthesized according to Synthesis Example 2 was dissolved in dimethyl sulfoxide to prepare a solution having a concentration of 10% by weight. From the obtained solution was produced an about 30 μm thick polymer electrolyte membrane by using a supporting substrate (PET film, manufactured by Toyobo Co., Ltd., E5000 grade with a thickness of 100 μm) under the conditions of a temperature of 70° C. and a specific humidity of 0.107 kg/kg. This membrane was immersed in 2 N sulfuric acid for 2 hours, then washed with ion-exchange water, and further air-dried to prepare a conductive membrane 4. The formed conductive membrane 4 was subjected to small-angle X-ray scattering measurement in accordance with Measurement Method 2 and Measurement Method 4, and as a result, the scattering angles 2θ_{z} and 2θᵢ in the membrane thickness direction and in the membrane surface direction were 0.550° and 0.380°, respectively, and the period length L in the membrane surface direction and the anisotropy k were 23.2 nm and 0.691, respectively. The proton conductivity was 0.142 S/cm.

### Comparative Example 1

A comparative membrane 1 was prepared by carrying out the experiment in the same manner as in Example 1 except that the temperature was 80° C. and the specific humidity was 0.055 kg/kg. The formed comparative membrane 1 was subjected to small-angle X-ray scattering measurement in accordance with Measurement Method 1 and Measurement Method 3, and as a result, the scattering angles 2θ_{z} and 2θᵢ in the membrane thickness direction and in the membrane surface direction were 0.370° and 0.140°, respectively, and the period length L in the membrane surface direction and the anisotropy k were 63 nm and 0.361, respectively. The proton conductivity was 0.101 S/cm.

### Comparative Example 2

A comparative membrane 2 was prepared by carrying out the experiment in the same manner as in Example 1 except that the temperature was 80° C. and the specific humidity was 0.002 kg/kg. The formed comparative membrane 2 was subjected to small-angle X-ray scattering measurement in accordance with Measurement Method 1 and Measurement Method 3, and as a result, the scattering angles 2θ_{z} and 2θᵢ in the membrane thickness direction and in the membrane surface direction were 0.445° and 0.135°, respectively, and the period length L in the membrane surface direction and the anisotropy k were 65.4 nm and 0.290, respectively. The proton conductivity was 0.081 S/cm.

TABLE 1
Conditions for membrane formation of each conductive membrane

| | Membrane formation | Specific humidity |
|---|---|---|
| | temperature (° C.) | (kg/kg) |
| Conductive membrane 1 | 70 | 0.048 |
| Conductive membrane 2 | 80 | 0.103 |
| Conductive membrane 3 | 90 | 0.116 |
| Conductive membrane 4 | 70 | 0.107 |
| Comparative membrane 1 | 80 | 0.055 |
| Comparative membrane 2 | 80 | 0.002 |

TABLE 2
Characteristics of Each Conductive Membrane

| | | 2θ_{z} (membrane | 2θᵢ (membrane surface | L (membrane surface | |
|---|---|---|---|---|---|
| | Conductivity (S/cm) | thickness direction, °) | direction, °) | direction, nm) | k |
| Example 1 (conductive | 0.154 | 0.340 | 0.185 | 47.7 | 0.519 |
| membrane 1) | | | | | |
| Example 2 (conductive | 0.146 | 0.365 | 0.170 | 51.9 | 0.445 |
| membrane 2) | | | | | |
| Example 3 (conductive | 0.121 | 0.370 | 0.175 | 50.4 | 0.451 |
| membrane 3) | | | | | |
| Example 4 (conductive | 0.142 | 0.550 | 0.380 | 23.2 | 0.691 |
| membrane 4) | | | | | |
| Comparative Example 1 | 0.101 | 0.370 | 0.140 | 63.0 | 0.361 |
| (comparative membrane 1) | | | | | |
| Comparative Example 2 | 0.081 | 0.445 | 0.135 | 65.4 | 0.290 |
| (comparative membrane 2) | | | | | |

### INDUSTRIAL APPLICABILITY

The proton conductive membrane obtained by the preparation method of the present invention exhibits excellent proton conductivity in the membrane thickness direction. Therefore, it can be suitably used for a cell using hydrogen or methanol as a fuel, specifically, in applications such as fuel cells for household power supply, fuel cells for automotives, fuel cells for mobile phones, fuel cells for PCs, fuel cells for portable terminals, fuel cells for digital cameras, fuel cells for portable CD and MD players, fuel cells for stereo headphones, fuel cells for pet robots, fuel cells for electric-power assisted bicycles, and fuel cells for electric-power scooters. In addition, according to the preparation method of the present invention, the polymer electrolyte membrane of the present invention can be easily prepared.

1. A polymer electrolyte membrane, wherein the period length L in the membrane surface direction, which period length is defined by formula (1) and is measured by using a small-angle X-ray diffractometer, is less than 52.0 nm:
L=λ₁/(2 sin(2θᵢ/2)) (1)
wherein 2θᵢ represents a scattering angle in the membrane surface direction and λ₁ represents the wavelength of X-rays used when the scattering angle in the membrane surface direction is measured.

2. The polymer electrolyte membrane according to claim 1, wherein the anisotropy factor k, which is defined by formula (2) and is measured by using a small-angle X-ray diffractometer, is more than 0.440:
k=(2θᵢ/λ₁)/(2θ_{z}/λ₂) (2)
wherein 2θᵢ and 2θ_{z} respectively represent a scattering angle in the membrane surface direction and a scattering angle in the membrane thickness direction, and λ₁ and λ₂ respectively represent the wavelength of X-rays used when a scattering angle in the membrane surface direction is measured and the wave length of X-rays used when a scattering angle in the membrane thickness direction is measured.

3. The polymer electrolyte membrane according to claim 1, comprising a polymer having an ion-exchange group.

4. The polymer electrolyte membrane according to claim 1, comprising a block copolymer containing at least one block having an ion-exchange group and at least one block having no ion-exchange groups.

5. The polymer electrolyte membrane according to claim 1, comprising a block copolymer containing one or more blocks having an aromatic group in the main chain or a side chain and having an ion-exchange group and one or more blocks having an aromatic group in the main chain or a side chain and having no ion-exchange groups.

6. The polymer electrolyte membrane according to claim 1, comprising a polyarylene-based block copolymer containing one or more blocks having at least one kind of an ion-exchange group selected from the group consisting of a phosphonic acid group, a carboxylic acid group, a sulfonic acid group and a sulfonimide group, and one or more blocks having no ion-exchange groups.

7. (canceled)

8. A method for preparing a polymer electrolyte membrane, the method comprising:
applying a solution containing a polymer electrolyte by a cast-application method to a substrate and
removing a solvent to obtain the polymer electrolyte membrane, wherein in the solvent-removing step, the specific humidity H (wherein 0≦H≦1) of the atmosphere of the step is kept in a range satisfying formula (3), and the Celsius temperature T of the atmosphere of the step is kept in a range satisfying formula (4):
0.0033T−0.2<H≦0.5 (3)
60≦T≦160 (4).

9. The polymer electrolyte membrane according to claim 2, comprising a polymer having an ion-exchange group.

10. The polymer electrolyte membrane according to claim 2, comprising a block copolymer containing at least one block having an ion-exchange group and at least one block having no ion-exchange groups.

11. The polymer electrolyte membrane according to claim 2, comprising a block copolymer containing one or more blocks having an aromatic group in the main chain or a side chain and having an ion-exchange group and one or more blocks having an aromatic group in the main chain or a side chain and having no ion-exchange groups.

12. The polymer electrolyte membrane according to claim 2, comprising a polyarylene-based block copolymer containing one or more blocks having at least one kind of an ion-exchange group selected from the group consisting of a phosphonic acid group, a carboxylic acid group, a sulfonic acid group and a sulfonimide group, and one or more blocks having no ion-exchange groups.

13. A solid polymer fuel cell formed by using the polymer electrolyte membrane according to any of claims 1 to 6, and 9 to 12.
